(19) United States
(12) Patent Application Publication
(10) Pub. No.: US 2008/0037253 A1
(43) Pub. Date: Feb. 14, 2008

(54) Illumination Device used in Barbeques

(76) Inventor: William T.M. Liao, Taichung Hsien (TW)

Correspondence Address: HDSL, 4331 STEVENS BATTLE LANE, FAIRFAX, VA, 22033, US

(21) Appl. No.: 11/463,707

(22) Filed: Aug. 10, 2006

(51) Int. Cl. F21V 21/26

(52) U.S. Cl. 362/269

(57) ABSTRACT

An illumination device used in a barbeque includes a base having a pivotal hole formed thereon, a lamp device having a pole extending therefrom configured to be pivotably mounted into the pivotal hole. The lamp device can rotate to the base so that the barbeque has a convenient operation.

### BACKGROUND OF THE INVENTION

1. Field of the Invention

The present invention relates to an illumination device used in barbeques, and particularly to an illumination device used in a barbeques having easy operation and compact size.

2. Description of the Related Art

Currently, barbeque is a popular outdoor action. Conventional barbeques have a rotating base to rotate a whole chicken or big food for enhancing the joy of the barbeque. Referring to FIG. 7, a rotating base 70 used in a barbeque includes a panel 71 corresponding to embed a grill of the barbeques and a rotating shift 75 for rotating the whole chicken in a horizontal direction. The rotating shift 75 is driven by a motor in the rotating base for uniformly heating the whole chicken. However, when the barbeque is used in the evening, it is difficult to find the food and judge the food cooked or not.

For solving the above problem, referring to FIG. 8, the rotating base further includes an immovable lamp device 80 as a light source to improve the brightness. Since the immovable lamp device 80 is fixed on the rotating base 70, the illuminative angle can not be adjust so that it can not effectively illuminate the whole food. Referring to FIG. 9, the rotating base 70 further includes a moveable lamp device 90 via a flexible pipe. The moveable lamp device 90 can adjust the illuminative angle, but it has bad positioning property, the illuminative angle changes optionally, and it occurs a large space.

What is needed is to provide an illumination device used in a barbeque with a convenient operation.

### BRIEF SUMMARY

An illumination device used in a barbeque according to a preferred embodiment includes a base having a pivotal hole formed thereon, a lamp device having a pole extending therefrom configured to be pivotably mounted into the pivotal hole.

The present illumination device makes the lamp device pivotably mounted on the base, so that the lamp device can rotate to the base, the illuminative angle can be adjusted. Therefore, the illumination device used in the barbeque has a convenient operation.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of an illumination device used in a barbeque in accordance with a first preferred embodiment of the present invention;

FIG. 2 is an exploded, isometric view of the illumination device of FIG. 1;

FIG. 3 is a schematic, cross-section view of the illumination device of FIG. 1;

FIG. 4 is a schematic, view of a barbeque using the illumination device of FIG. 1;

FIG. 5 is a schematic, view of the barbeque having a rotating pole of FIG. 4;

FIG. 6 is a schematic, cross-section view of an illumination device used in a barbeque in accordance with a second preferred embodiment of the present invention;

FIG. 7 is a schematic view of a conventional rotating base;

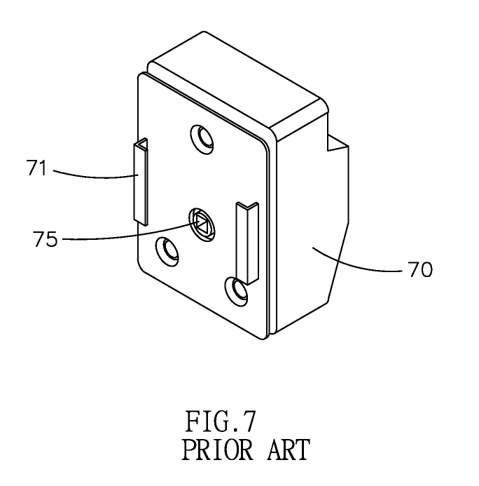

FIG. 8 is a schematic view of another conventional rotating base having an immoveable lamp device; and

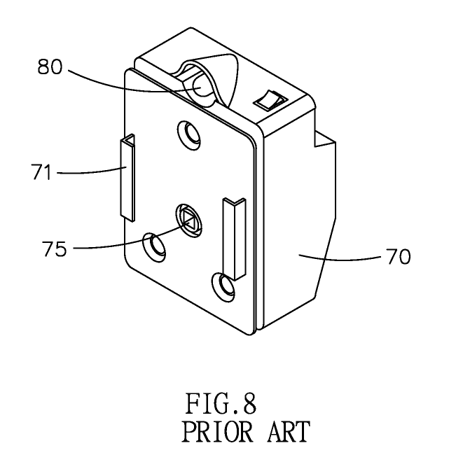

FIG. 9 is a schematic view of other conventional rotating base having a moveable lamp device.

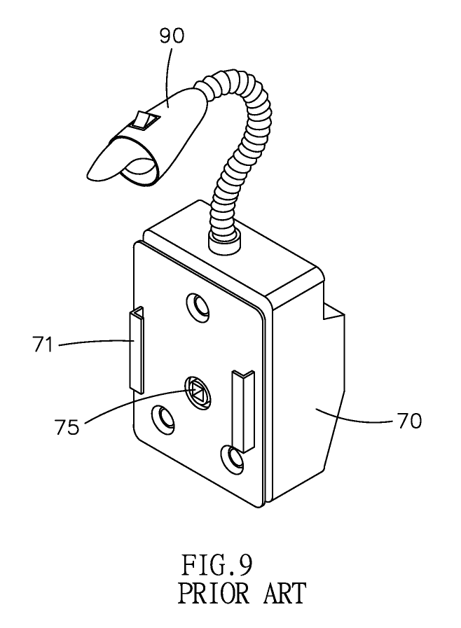

### DETAILED DESCRIPTION

Reference will now be made to the drawings to describe a preferred embodiment of the present illumination device used in a barbeque, in detail.

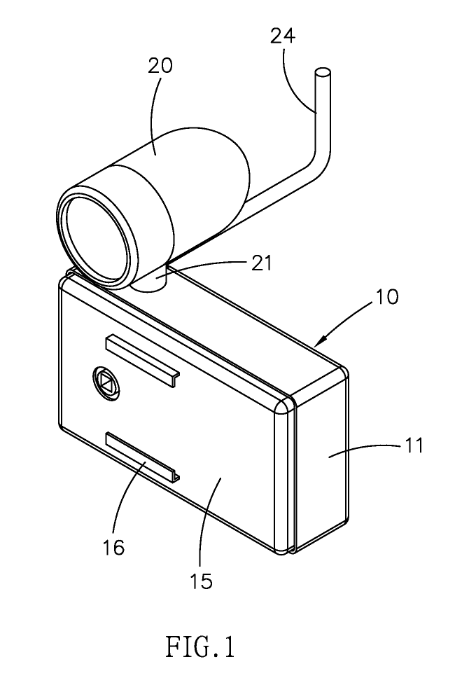

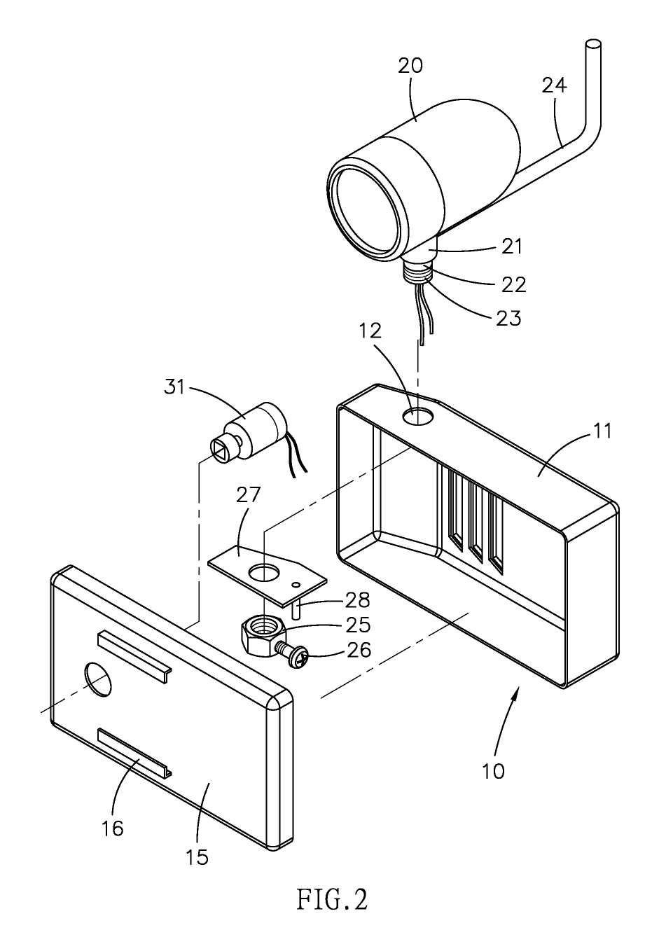

Referring to FIGS. 1 to 3, an illumination device used in a barbeque in accordance with a first preferred embodiment is shown. The illumination device includes a base 10 and a lamp device 20 pivotably mounted on one surface of the base, such as the top surface.

The base 10 includes a first shell 11 and a second shell 15 which can cover the first shell 11. The first shell 11 has a pivotal hole 12 formed on the top surface thereof for pivotably connecting with the lamp device 20. The second shell 15 has two L-shaped panels 16 formed on a surface corresponding to the barbeque 50 so that the base 10 can be embedded into a support base 55 of the barbeque 50.

The lamp device 20 has a light source, such as a light tube or a light emitting diode. The lamp device 20 has a pole 21 extending from the lamp device 20 for making the lamp device 20 rotate into the pivotal hole 12 of the base 10. The pole 21 has a pivotal portion 22 extending from the pole 21 and a screwing portion 23 extending from the pivotal portion 22. The pivotal portion 22 inserts into the pivotal hole 12 and the screwing portion 23 is locked by a screw cap 25 so that the lamp device 20 can pivotably mounted on the base 10. A wrench 24 is formed at the periphery of the pole 21 for easily turning the lamp device 20 to adjust the illumination angle. A stop pole 26 is formed at the periphery of the screw cap 25 and a limiting pole 28 extends from the inner surface of the first shell 11 of the base 10 for preventing the electrical wire winding the stop pole 26. The limiting pole 28 further includes a fixing sheet 27 for easy assembly at the pivotal portion 22 of the pole 21.

The user adjusts the illuminative angle of the lamp device 20 by controlling the wrench 24 so that the barbeque can be used in the evening or the dark environment.

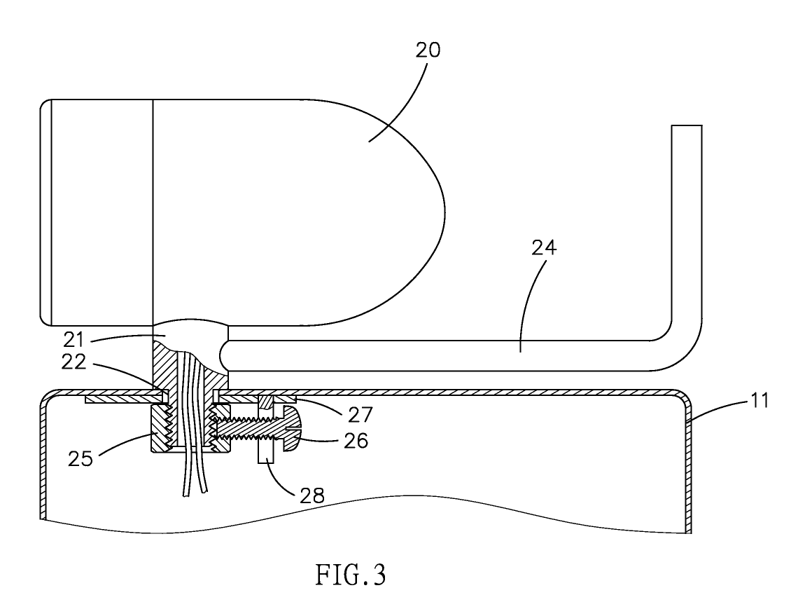

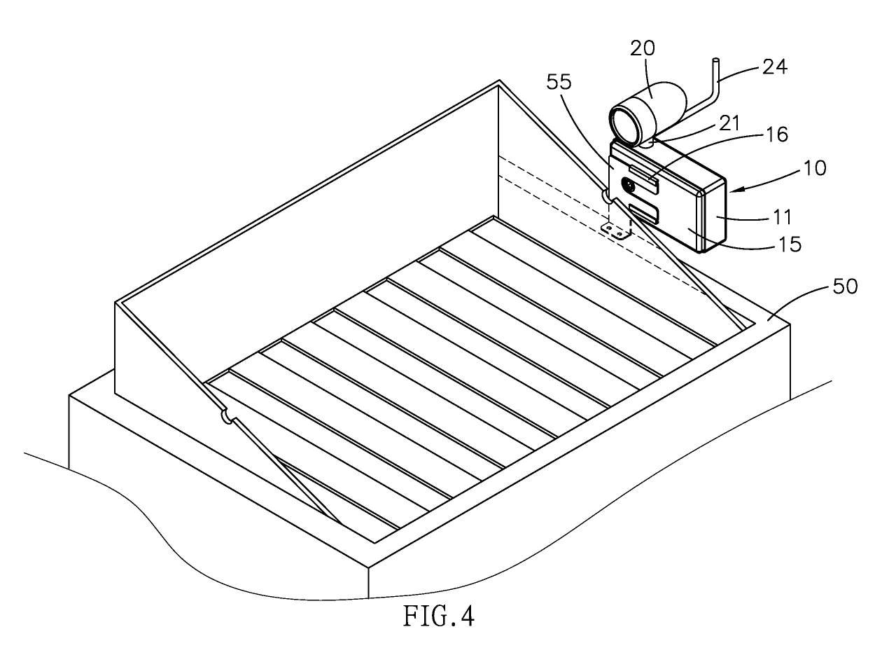

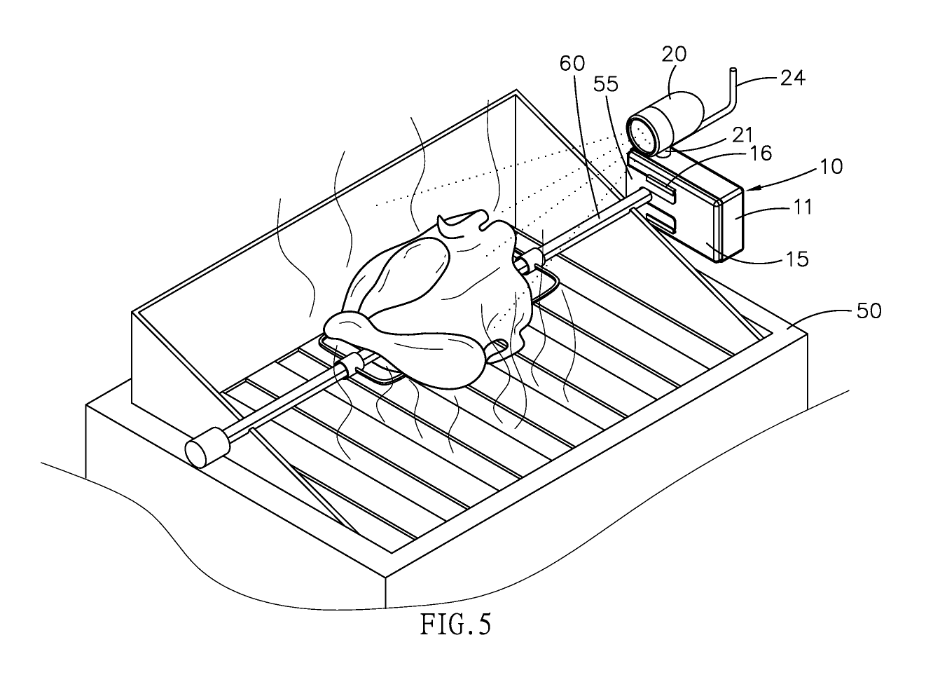

Referring to FIGS. 3 to 5, when operation, the illumination device can be fixed on the support base 55 of the barbeque 50 by the panels 16 of the base 10. The base 10 is connected with a rotating pole 60 driven by a motor 31. The rotating pole 60 is configured for rotating the food thereon. When the environment is dark, the illuminative angle of the lamp device 20 can be adjusted by controlling the wrench 24. Furthermore, the lamp device 20 turns around the base 10 through pole 21 so that the adjustment is easy.

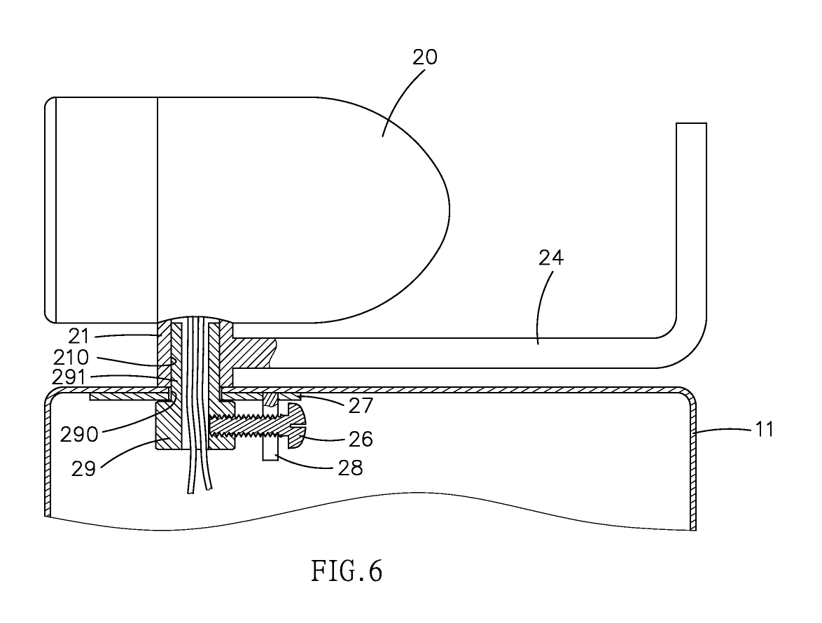

Referring to FIG. 6, an illumination device used in a barbeque in accordance with a second preferred embodiment is shown. The illumination device is similar to that of the first preferred embodiment, except that the pole 21 of the lamp device has a screwing hole 210 formed therein. A locking pole 29 having a corresponding screwing portion 291 makes the lamp device turn into the pivotal hole 12. The locking pole 29 further includes a pivotal portion 290 inserting into the pivotal hole 12. The pivotal portion 290 has a higher length than the depth of the pivotal hole 12.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An illumination device used in a barbeque, comprising:
a base having a pivotal hole formed thereon;
a lamp device having a pole extending therefrom, configured to be pivotably mounted into the pivotal hole.

2. The illumination device as claimed in claim 1, wherein the base further comprises a rotating pole extending to the barbeque, the rotating pole being driven by a power device.

3. The illumination device as claimed in claim 1, wherein the base further comprises a first shell and a second shell covered thereon, the pivotal hole is formed at a top surface of the first shell, and the base further comprises two opposite panels configured to be embedded into a support base of the barbeque.

4. The illumination device as claimed in claim 1, wherein the lamp device further comprise a light source, and the light source is selected from a group consisting of a light tube and a light emitting diode.

5. The illumination device as claimed in claim 1, wherein the pole has a pivotal portion extending from the pole and a screwing portion extending from the pivotal portion, and the pivotal portion is inserted into the pivotal hole and the screwing portion is locked by a screw cap.

6. The illumination device as claimed in claim 1, wherein the pole has a screwing hole defined therein, configured for making the lamp device turn into the pivotal hole by a locking pole having a corresponding screwing portion.

7. The illumination device as claimed in claim 1, wherein the pole further includes a stop pole formed at a periphery thereof, the base has a limiting pole formed on an inner surface of the base configured for preventing an electrical wire winding around the stop pole.

8. The illumination device as claimed in claim 2, wherein the power device is a motor.

9. The illumination device as claimed in claim 7, wherein the limiting pole has a fixing sheet configured for easily assembling into the pivotal portion of the pole.

10. The illumination device as claimed in claim 1, wherein the lamp device further comprises a wrench configured for controlling the illuminative angle of the lamp device.
